(19) United States
(12) Patent Application Publication
(10) Pub. No.: US 2012/0096677 A1
(43) Pub. Date: Apr. 26, 2012

(54) Style of safety door hinge design

(76) Inventor: Jung-Yung Ho, (US)

(21) Appl. No.: 13/200,981

(22) Filed: Oct. 6, 2011

(30) Foreign Application Priority Data
Oct. 21, 2010 (TW) 099220393
Jun. 14, 2011 (TW) 100210770

(51) Int. Cl. E05D 7/10; E05D 11/00

(52) U.S. Cl. 16/250

(57) ABSTRACT

This utility model is an embodiment of indoor safety door hinge design, which is composed of a fixed part, a connection part, and an axle rod, which makes fixed parts connect with connector; said connector is composed of splice and second sleeve; which is characterized in that the lower pat of axle rod (3) is inserted into first sleeve (12) and shaved into parallel planes narrow stick (31); the side of first sleeve (12) can form a rectangular notch (13) after narrow stick of axle rod is pulled. Thus, the safety door hinge can be pulled to open without breaking the body of door, and indoor people, and recover it.

### FIELD OF THE INVENTION

This utility model is an embodiment of indoor safety door hinge design

### DESCRIPTION OF PRIOR ARTS

As human technology progress, hardware technology improves, and the architecture progress too. In modern windows and doors, to facilitate its open and close, people adopt hinge as the connection part of window and frame; said link is used as connection to two parts of technical structure; links are separated into two parts, which are slice links and ground links; slice links are formed of two slice with a axis, and one of slices is fixed on the wall with screw pieces; the other part of slice is fixed on the side part of window; when open or close, two slices of links make overturn with central axis to reach the aim of open and close.

### SUMMARY OF THE INVENTION

### First: The Problem to be Solved

The door in rotation form cannot open from outside when the indoor is blocked; if the seniors faint in bathroom, or the material fall on grounds may hinder the door to open; people cannot open the door to save the patients; it will take some time for rescues to break the door, and spend the money to recover it; thus how can people take apart the door and recover it again without breaking the door in a faster speed becomes the main top of this invention.

### Second: Invention Technique

A style of safety door hinge design, includes:

A first door hinge (10) on upper side of door body (7) and connect with door frame (6) and a door body (7) on the same side of first door hinge (10), and connect with second door hinge (20) of door frame (6).

Said first door hinge (10) and second door hinge (20) are composed of fixed parts (1), connector (2), and axle rod (3); connector (2) match with fixed parts (1) on up and down side; axle rod (3) connect with connector (2);

said fixed parts (1) is composed of fixed sheet (11) and first sleeve (12); connector (2) is composed of splice (21), and second sleeve (22);

The upper part of said axle rod (3) insert into second sleeve (22), and the lower part of said axle rod (3) insert into first sleeve (12) and said rectangular notch (13) opens at top and close at end;

which is characteristic in that:
said narrow stick base (32) of narrow stick (31) of second door hinge (20) is close to rectangular notch (13) and has a cave part (33); said hemline (14) of rectangular notch (13) of second door hinge (20) has a cover lump (15) corresponds to cave part (33).

According to the description above, said narrow stick (31) of axle rod axle rod (3) and angle (D) of rectangular notch (13) is in stagger shape of fixed parts (1) and connector (2); after a rotation of connector (2), narrow stick (31) of axle rod (3) can match with rectangular notch (13) in same angle (D).

According to the description above, said rectangular notch rectangular notch (13) has a protecting cover (4) to prevent unnecessary material falling from protecting cover (4) inside first sleeve (12).

According to the description above, said protecting cover (4) is composed of insertion member (41) inside rectangular notch (13), and fixed member (42), which match with insertion member (41) to cover first sleeve (12).

According to the description above, said first sleeve (12) and second sleeve (22) has a design of a dustproof cover (5) to prevent from unnecessary material falling.

According to the description above, said fixed sheet (11) of fixed parts (1) is fixed on the inside part of door frame (6) and splice (21), which connects with connector (2) is on the side part of door body (7).

According to the description above, said fixed sheet (11) of fixed parts (1) fixed on the side part of door body (7), and the connector (2) of splice (21) is fixed on the side part of door frame (6).

According to the description above, said horizon face (331) of cave part (33) is lower than rectangular notch (13).

Said first door hinge (10) and second door hinge (20) are composed of fixed parts (1) and connector (2), corresponding to fixed parts (1), and axle rod (3) which makes fixed parts (1) and connector (2) connect;

said fixed parts (1) is composed of fixed sheet (11) and a first sleeve (12) which combines with fixed sheet (11); said connector (2) is composed of splice (21) and a first sleeve (12) which connects splice (21) on the side part;

the upper part of said axle rod (3) inset into second sleeve (22) and the lower part inset into first sleeve (12), and is shaved to narrow stick (31) which is parallel to the plane;

the side part of first sleeve (12) forms a rectangular notch (13) after the pressure of narrow stick (31), and said rectangular notch (13) is open on the upper side and close on the down side;

which is characteristic in that:

Narrow stick (31) of second door hinge (20) on the narrow stick base (32), there is a cave part (33) which close to rectangular notch (13); rectangular notch (13) of second door hinge (20) on hemline (14), there is a corresponding cover lump (15) which corresponds to cave part (33).

About the invention of first door hinge (10), the embodiments of it are as follows:

A style of safety door hinge design is characterized in that:

said first door hinge (10) is composed of fixed parts (1), connector (2), which corresponds to fixed parts (1), and axle rod (3); said fixed parts (1) is composed of fixed sheet (11) and first sleeve (12); said connector (2) is composed of splice (21), first sleeve (12) and second sleeve (22);

which is characteristic in that:

the upper part of said axle rod (3) insert into second sleeve (22) to fasten, and the lower part of axle rod (3) insert into first sleeve (12) and narrow stick (31), which was shaved into parallel planes; said first sleeve (12) can form a rectangular notch (13) to offer narrow stick (31) of axle rod (3); said rectangular notch (13) is open for upper part and close for end part.

Said narrow stick (31) of axle rod (3) and the angle of rectangular notch (13) are in stagger shape in fixed parts (1) and connector (2); after the rotation of connector (2), narrow stick (31) of axle rod (3) can match with rectangular notch (13) in the same angle.

Said rectangular notch (13) has a protecting cover (4) to prevent dust falling from first sleeve (12).

Said protecting cover (4) is composed of insertion member (41) of rectangular notch (13) and fixed member (42), which connect with insertion member (41) and cover to outer of first sleeve (12).

Said first sleeve (12) and the outer part of second sleeve (22) has a dustproof cover (5) to prevent from dust.

Said fixed sheet (11) of fixed parts (1) is fasten to the inside part of door frame (6), and splice (21) of connector (2) attach to the side part of door body (7).

Said fixed sheet (11) of fixed parts (1) is fasten to the side part of door body (7), and splice (21) of connector (2) is fasten to the inside part of door frame (6).

### Third: The Comparison to the Prior Art

Through the corresponding position of narrow stick base (33) and cover lump (15), there is a resistance when door body (7) is taken apart; in this way, door body (7) can be taken apart without doing damage to people or objects over the door.

This invention can make narrow stick (31) of axle rod (3) and rectangular notch (13) in the same angle and make narrow stick (31) take off from first sleeve (12) to tear down the door; it is easy to take the door apart without being damaged so that the door can be repaired again.

### DETAILED DESCRIPTION OF THE PREFERRED EMBODIMENTS

The embodiments of the description are as follows:

FIG. 1: shows a schematic view of this invention;

FIG. 2: shows a decomposition view of FIG. 1;

FIG. 3: shows a section view of FIG. 1;

FIG. 4: shows a relation view of fixed parts and door frame;

FIG. 5: shows a relation view of connector and door body;

FIG. 6: shows the schematic view of FIG. 1 after action (a);

As FIG. shows, a safety style of hinge includes:
A first door hinge (10) on upper side of door body (7) and connect with door frame (6) and a door body (7) on the same side of first door hinge (10), and connect with second door hinge (20) of door frame (6).
Said first door hinge (10) and second door hinge (20) are composed of fixed parts (1), connector (2), and axle rod (3); connector (2) match with fixed parts (1) on up and down side; axle rod (3) connect with connector (2);
   said fixed parts (1) is composed of fixed sheet (11) and first sleeve (12);
   connector (2) is composed of splice (21), and second sleeve (22);

The upper part of said axle rod (3) insert into second sleeve (22), and the lower part of said axle rod (3) insert into first sleeve (12) and said rectangular notch (13) opens at top and close at end;

which is characteristic in that:

said narrow stick base (32) of narrow stick (31) of second door hinge (20) is close to rectangular notch (13) and has a cave part (33);

said hemline (14) of rectangular notch (13) of second door hinge (20) has a cover lump (15) corresponds to cave part (33).

The corresponding position of cave part (33) and cover lump (15) can have a resistance when door body (7) is taken apart through the match of cover lump (15) and cave part (33); cover lump (15) can stop vertical face (332) of cave part (33) to prevent door body (7) and door frame (6) from falling so that door body (7) will not fall instantly and do damage to people or objects by the door side.

When there is a emergency, the users can open the door with 5 to 8 degrees to test the distance between door body (7) and objects; fasten the door with one hand, and push or pat to the upper part of first door hinge (10) and second door hinge (20); the upper part of first door hinge (10) and second door hinge (20) will break with door frame (6) and door body (7) to make door body (7) and door frame (6) incline inside.

The lower part of second door hinge (20), by the corresponding position of cave part (33) and cover lump (15) make the lower part of door frame (6) and door body (7) hold the weight of door; in addition, with the catch of hand, door body (7) will not fall down to hit people; if users uplift door body (7), people can totally tear down door body (7) and door frame (6) to rescue people catch the objects inside.

The users can put back the door to entire door body (7) to door frame (6), once they reach the height of 140 cm.

With the overturn angle, the size difference and gravity, it will not be a problem with the fall of door body (7), and without the danger of twice damage.

According to the description above, a style of safety door hinge design is characterized in that: the angle of rectangular notch rectangular notch (13) formed by axle rod axle rod (3) and narrow stick narrow stick (31) staggers when fixed parts fixed parts (1) and connector (2) corresponds to each other; after the rotation of connector (2), axle rod (3) of narrow stick (31) can match with rectangular notch (13) in a same angle.

A style of safety door hinge design is characterized in that:

Said rectangular notch (13) has a protecting cover (4) to prevent dust falling from first sleeve (12).

A style of safety door hinge design is characterized in that: said protecting cover (4) is composed of insertion member (41) of rectangular notch (13) and fixed member (42), which connect with insertion member (41) and cover to outer of first sleeve (12).

A style of safety door hinge design is characterized in that: said first sleeve (12) and the outer part of second sleeve (22) have a dustproof cover (5) to prevent from dust.

A style of safety door hinge design is characterized in that: said fixed sheet (11) of fixed parts (1) is fasten to the inside part of door frame (6), and splice (21) of connector (2) attach to the side part of door body (7).

A style of safety door hinge design is characterized in that: said fixed sheet (11) of fixed parts (1) is fasten to the side part of door body (7), and splice (21) of connector (2) is fasten to the inside part of door frame (6).

There are two types of fixed parts (1) and connector (2); the description here shows only one of them, and either type one or two belong to the scope of the patent.

As FIG. 7 to FIG. 10 shows, the characteristic of first door hinge (10) is in that:

said first door hinge (10) is composed of fixed parts (1), connector (2), which corresponds to fixed parts (1), and axle rod (3); said fixed parts (1) is composed of fixed sheet (11) and first sleeve (12); said connector (2) is composed of splice (21), first sleeve (12) and second sleeve (22);

which is characteristic in that:

the upper part of said axle rod (3) insert into second sleeve (22) to fasten, and the lower part of axle rod (3) insert into first sleeve (12) and narrow stick (31), which was shaved into parallel planes; said first sleeve (12) can form a rectangular notch (13) to offer narrow stick (31) of axle rod (3); said rectangular notch (13) is open for upper part and close for end part.

A style of safety door hinge design is characterized in that: said fixed sheet (11) of fixed parts (1) is fasten to the inside part of door frame (6), and splice (21) of connector (2) attach to the side part of door body (7).

A style of safety door hinge design is characterized in that: said fixed sheet (11) of fixed parts (1) is fasten to the side part of door body (7), and splice (21) of connector (2) is fasten to the inside part of door frame (6).

In the description here, there are two types. Either type one or type two belong to the scope of this invention.

As FIG. 9 shows, narrow stick base (32) of axle rod (3) is a little bit higher or lower than hemline (14) of rectangular notch (13); when hemline (14) is higher, narrow stick (31) can easily be withdrawn from rectangular notch (13); when narrow stick base (32) of axle rod (3) is lower than hemline (14) for 0.1 cm to 0.3 cm, narrow stick (31) cannot easily be withdrawn from rectangular notch (13) unless the users have to raise narrow stick base (32) higher than hemline (14); the advantage of it is to prevent door body (7) from wind or vibration. Whether which type, they all belong to this patent scope.

As FIG. 10 shows, the arc of fixed member (42) is bigger than the radius of first sleeve (12) to cover first sleeve (12).

Said first sleeve (12) and second sleeve (22) has a design of dustproof cover (5) to prevent dust into second sleeve (22), and free from the problem of consumption of two sleeves.

As FIG. 12 to FIG. 16 shows, as reference to FIG. 12, when door body (7) and door frame (6) close, narrow stick (31) of axle rod (3) and rectangular notch (13) of first sleeve (12) are in small angle, 5 degrees for example, with the out force to inside force for door body (7), narrow stick (31) will go off from rectangular notch (13) with the stop of first sleeve (12) so as to make door body (7) no way to be out of door frame (6).

Moreover, as FIG. 13 shows, when door body (7) rotate a bit of degree, 5 degrees for example, it can make the narrow stick (31) and rectangular notch (13) of first sleeve (12) match; if users uplift door body (7) for 0.1 cm, narrow stick (31) will force protecting cover (4) of rectangular notch (13) fall and withdraw narrow stick (31) out of rectangular notch (13) as FIG. 14 shows.

If we view from 3-D, we can know clearly from FIG. 15 and FIG. 16. The connector (2) in FIG. 15 connect to fixed parts (1) by connector (2), and the upper part of axle rod (3) is to connect with second sleeve (22) of connector (2); the lower part of axle rod (3) can be inserted into first sleeve (12) of fixed parts (1) with narrow stick (31); narrow stick (31) will be off from first sleeve (12) when narrow stick (31) and first sleeve (12) match with each other to force narrow stick (31) to push protecting cover (4); so as to reach the aim of connector (2) and fixed parts (1) off.

As FIG. 17 shows, fixed parts (1) and connector (2) can unit with door frame (6) and door body (7); when the door was stop by people or objects, door body (7) and door frame (6) will be apart; people outside of the door have to rotate a little bit and uplift to lift or right side as FIG. 18 shows, to make door body (7) out of door frame (6), without the rotation of door, users can easily open the door to save people inside or remove the objects inside.

On the contrary, if the users want to load door body (7) back to door frame (6), he or she will have to match narrow stick (31) of axle rod (3) and rectangular notch (13) to make narrow stick (31) into first sleeve (12) and unit door body (7) and door frame (6).

According to the description above, the function, structure, and characteristics of the invention fit to the progressiveness and novelty; the description above shows the better example, and is not limited to the embodiment; any change confer to the invention here belongs to the scope of this invention.

### BRIEF DESCRIPTION OF THE DRAWINGS

FIG. 1: shows a schematic view of this invention;

FIG. 2: shows a decomposition view of FIG. 1;

FIG. 3: shows a section view of FIG. 1;

FIG. 4: shows a relation view of fixed parts and door frame;

FIG. 5: shows a relation view of connector and door body;

FIG. 6: shows the schematic view of FIG. 1 after action (a);

FIG. 7: shows the 3-D view of this invention;

FIG. 8: shows the decomposition view of FIG. 7;

FIG. 9: shows the section view of FIG. 7;

FIG. 10: shows the schematic view of fixed parts and door frame;

FIG. 11: shows the schematic view of connector and main door;

FIG. 12: shows the schematic view of action (a) for FIG. 7;

FIG. 13: shows the schematic view of action (b) for FIG. 7;

FIG. 14: shows the schematic view of action (c) for FIG. 7;

FIG. 15: shows the schematic view of action (a) for FIG. 14;

FIG. 16: shows the schematic view of action (b) for FIG. 14;

FIG. 17: shows the usage example of schematic view;

FIG. 18: shows the schematic view after the use of 17.

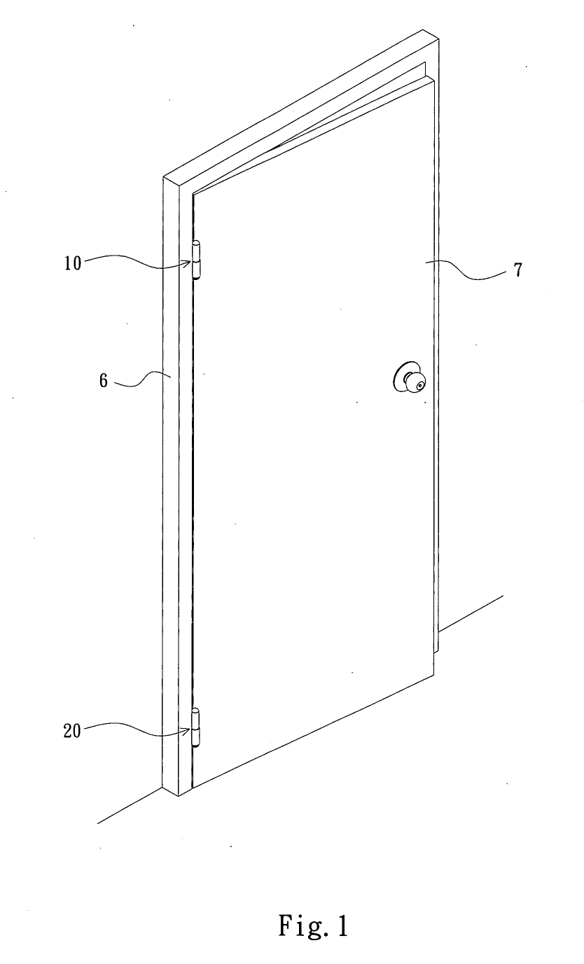

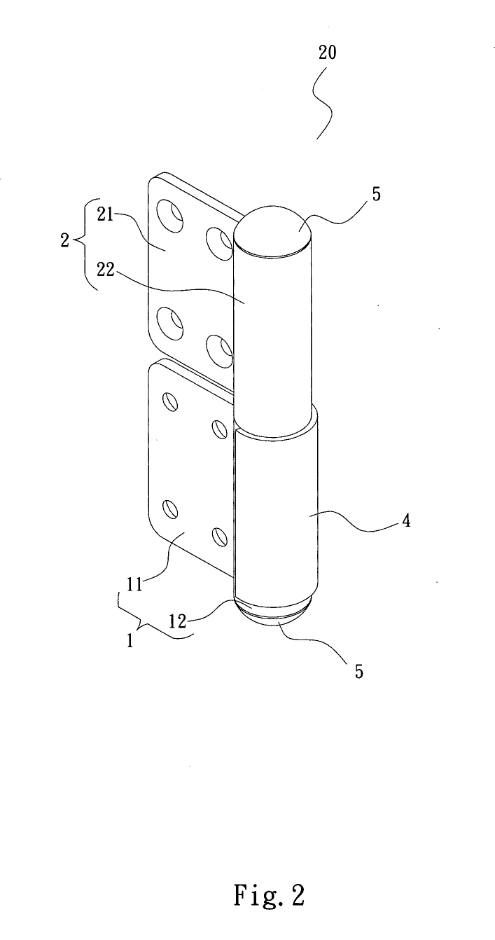

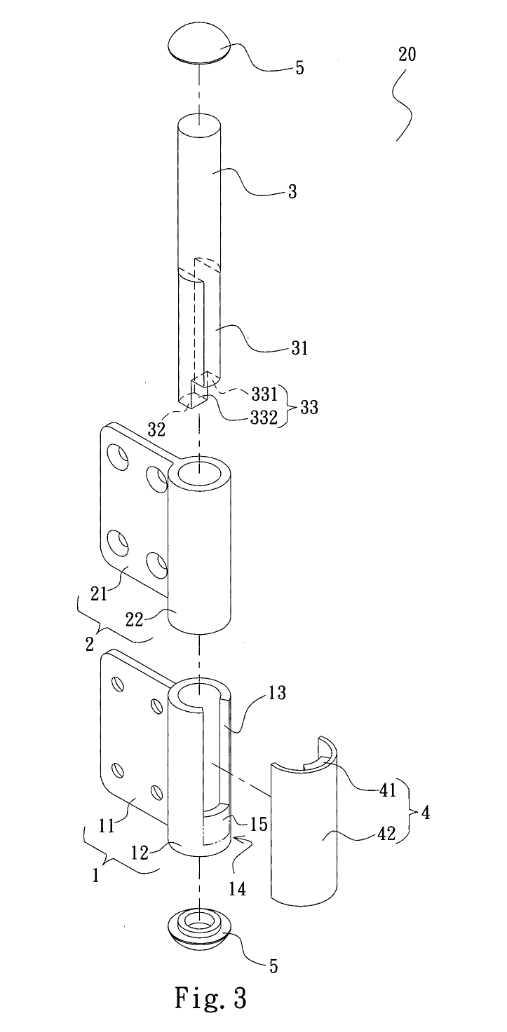

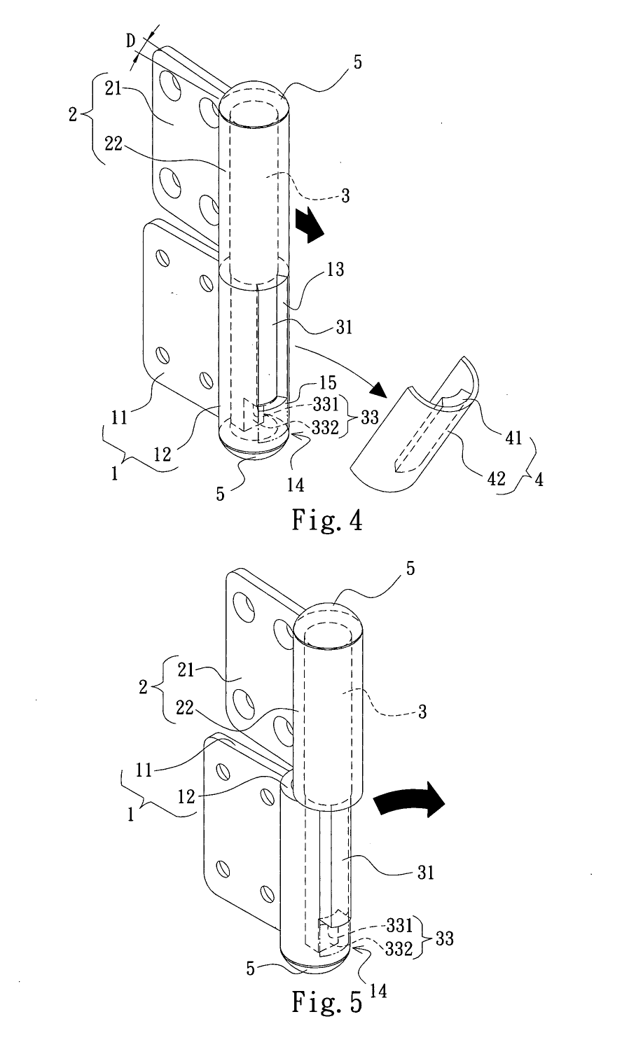

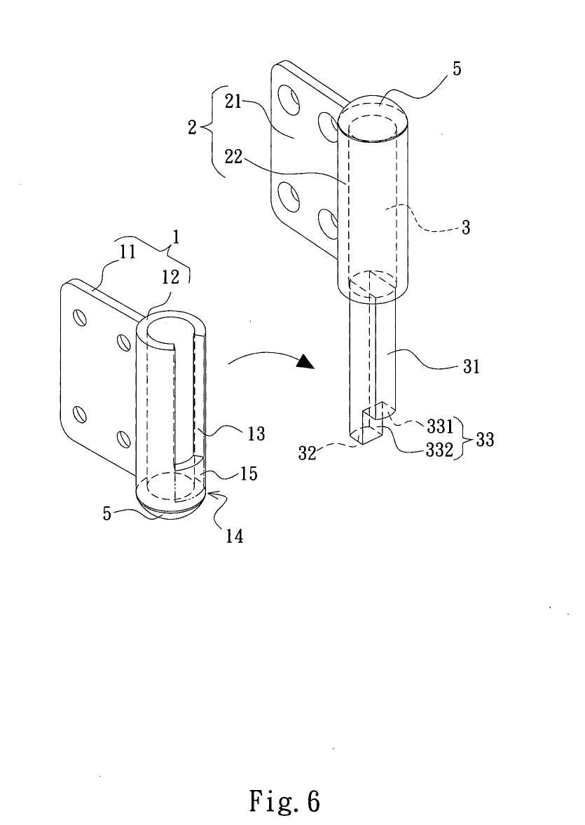

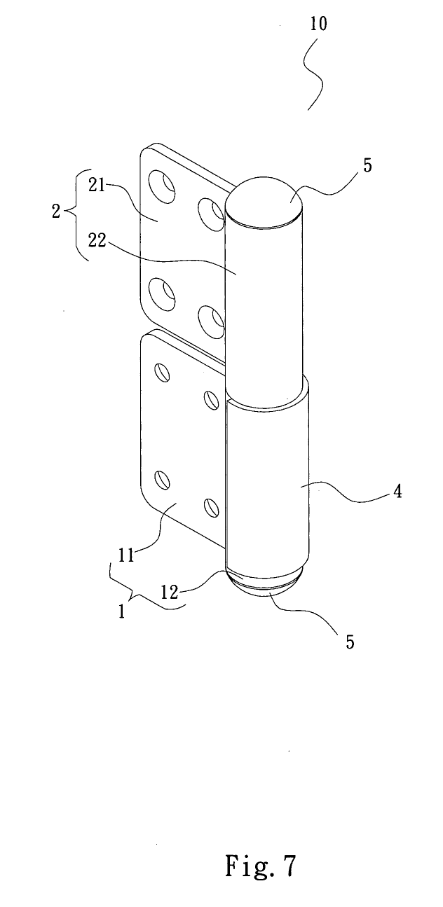

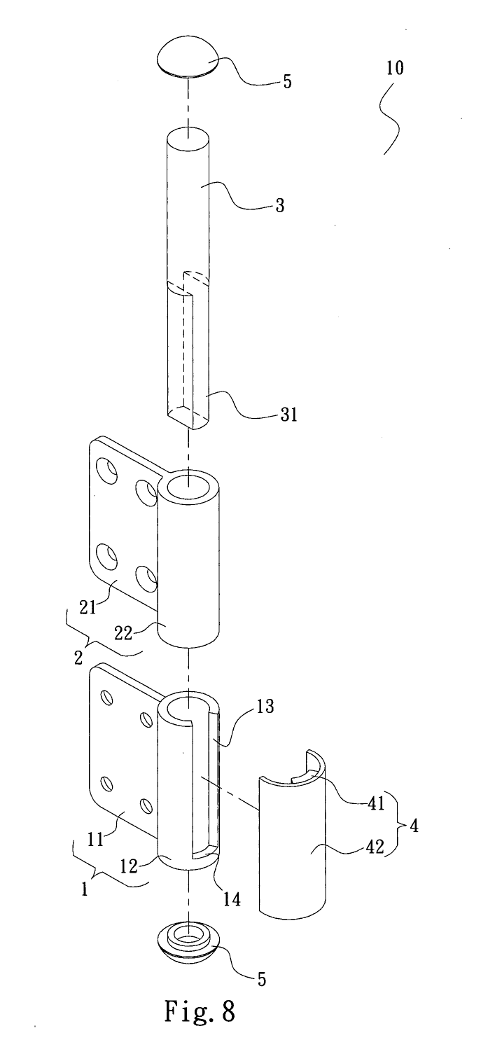

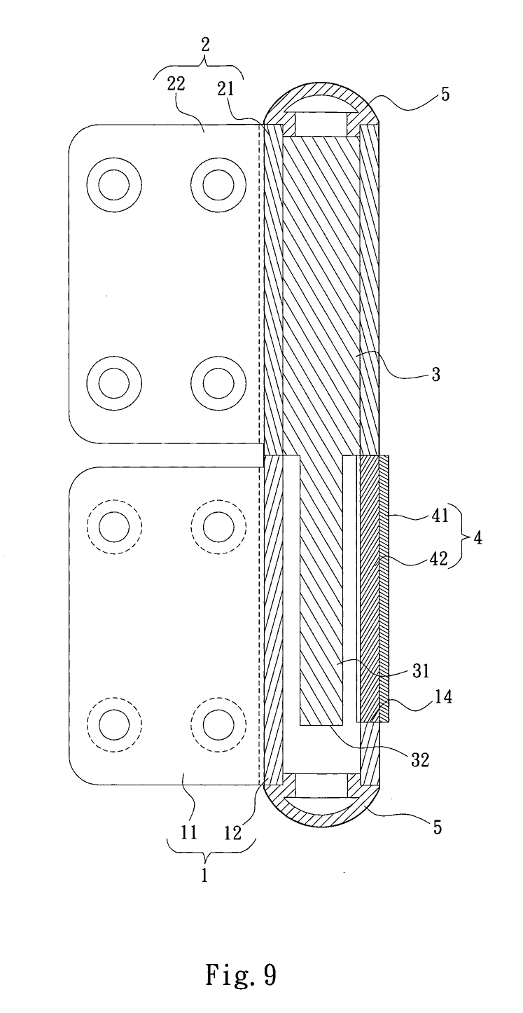

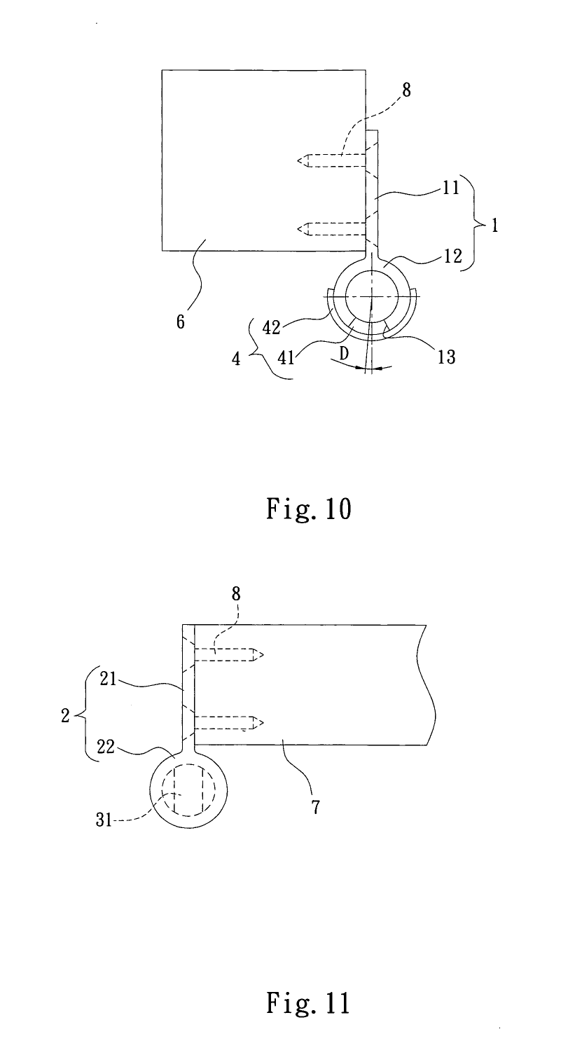

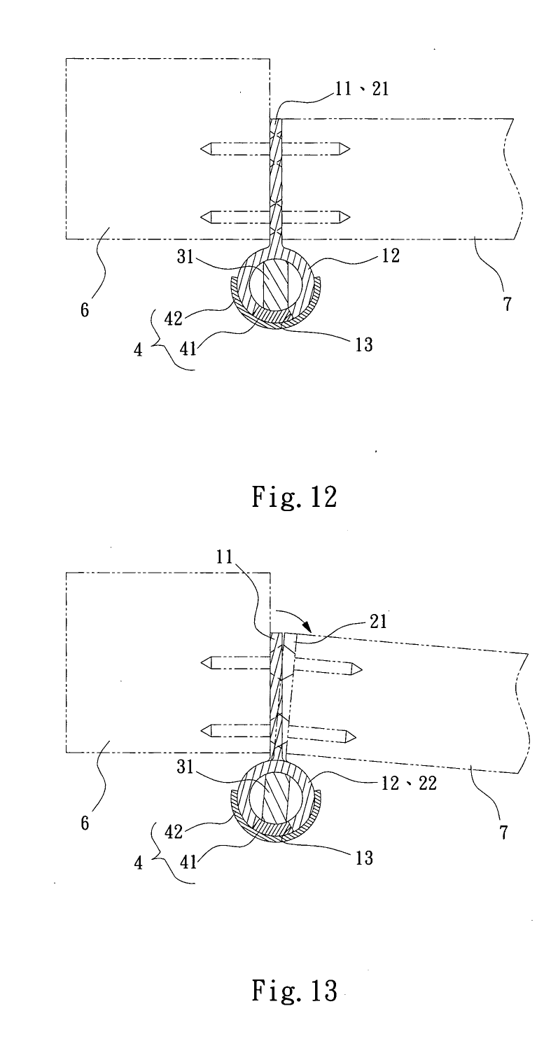

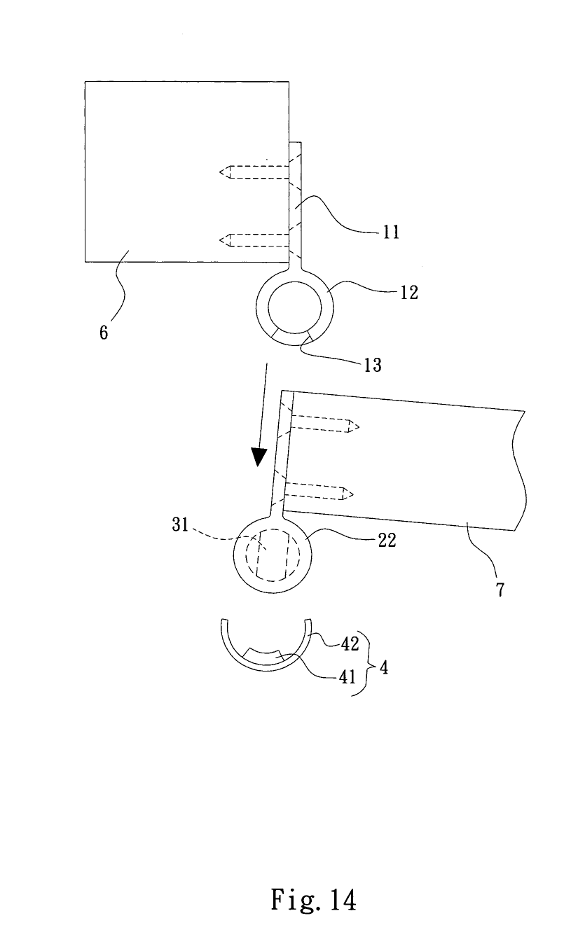

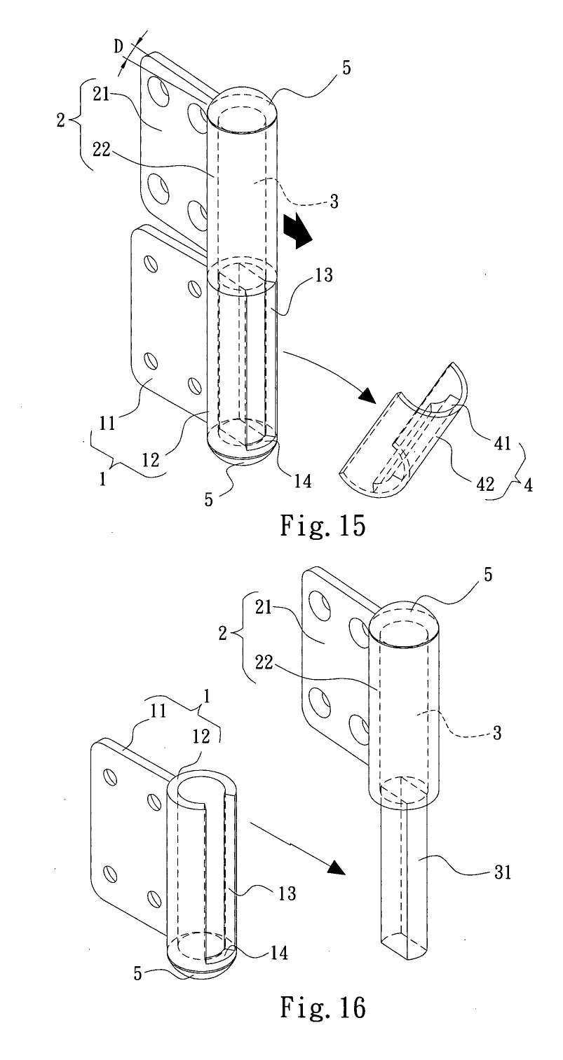

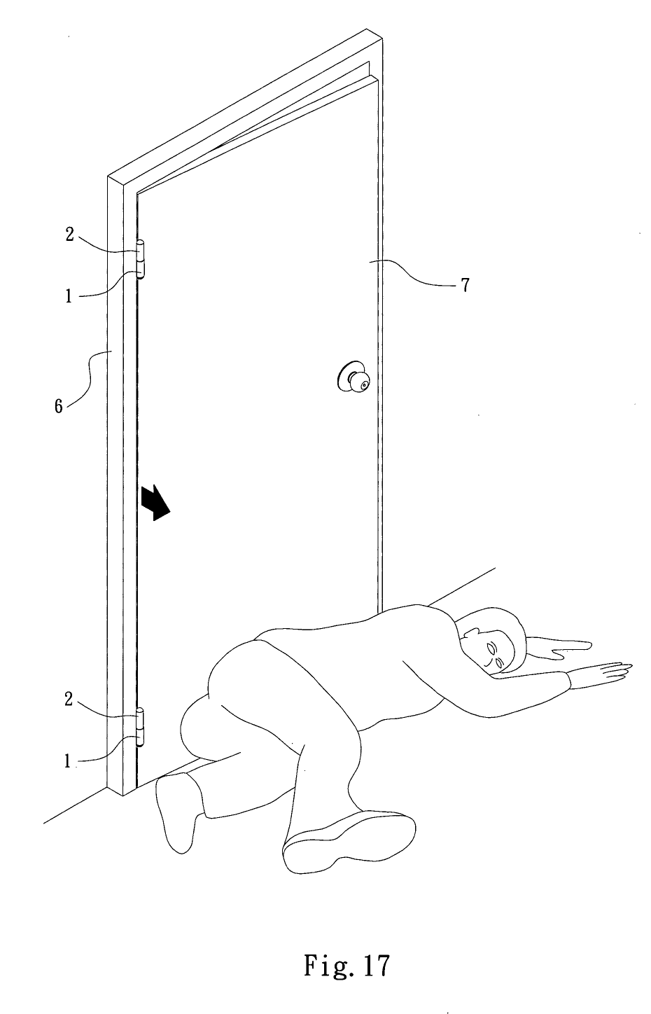

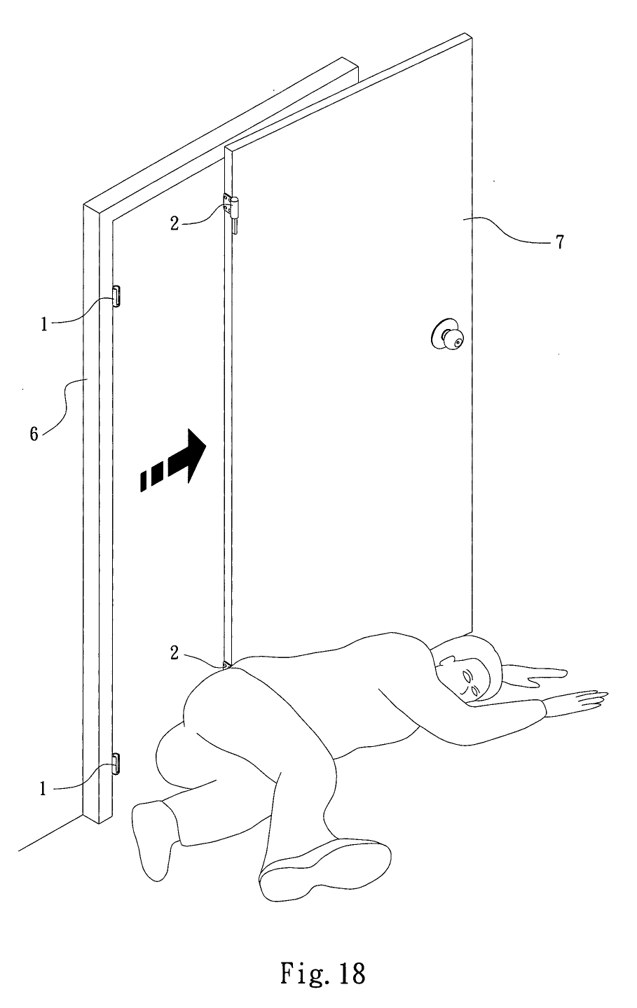

What is claim is:

1. A style of safety door hinge design, includes:
A first door hinge (10) on upper side of door body (7) and connect with door frame (6) and a door body (7) on the same side of first door hinge (10), and connect with second door hinge (20) of door frame (6).
Said first door hinge (10) and second door hinge (20) are composed of fixed parts (1), connector (2), and axle rod (3); connector (2) match with fixed parts (1) on up and down side; axle rod (3) connect with connector (2);
said fixed parts (1) is composed of fixed sheet (11) and first sleeve (12);
connector (2) is composed of splice (21), and second sleeve (22);
The upper part of said axle rod (3) insert into second sleeve (22), and the lower part of said axle rod (3) insert into first sleeve (12) and said rectangular notch (13) opens at top and close at end;
which is characteristic in that:
said narrow stick base (32) of narrow stick (31) of second door hinge (20) is close to rectangular notch (13) and has a cave part (33);
said hemline (14) of rectangular notch (13) of second door hinge (20) has a cover lump (15) corresponds to cave part (33).

2. A style of safety door hinge design according to claim 1 is characterized in that:
said narrow stick (31) of axle rod (3) and angle (D) of rectangular notch (13) is in stagger shape of fixed parts (1) and connector (2); after a rotation of connector (2), narrow stick (31) of axle rod (3) can match with rectangular notch (13) in same angle (D).

3. A style of safety door hinge design according to claim 1 is characterized in that:
said rectangular notch (13) has a protecting cover (4) to prevent unnecessary material falling from protecting cover (4) inside first sleeve (12).

4. A style of safety door hinge design according to claim 3 is characterized in that:
said protecting cover (4) is composed of insertion member (41) inside rectangular notch (13), and fixed member (42), which match with insertion member (41) to cover first sleeve (12).

5. A style of safety door hinge design according to claim 1 is characterized in that:
said first sleeve (12) and second sleeve (22) has a design of a dustproof cover (5) to prevent from unnecessary material falling.

6. A style of safety door hinge design according to claim 1 is characterized in that:
said fixed sheet (11) of fixed parts (1) fixed on the side part of door body (7), and the connector (2) of splice (21) is fixed on the side part of door frame (6);

7. A style of safety door hinge design according to claim 1 is characterized in that:
Said fixed sheet (11) of fixed parts (1) is on door body (7) side, and splice (21) of connector (2) is fixed on the side of door frame (6).

8. A style of safety door hinge design according to claim 1 is characterized in that:
Said horizon face (331) of cave part (33) is lower than rectangular notch (13).

9. A style of safety door hinge design according to claim 1 is characterized in that:
Said first door hinge (10) is composed of fixed parts (1), connector (2), which corresponds to fixed parts (1), and axle rod (3); said fixed parts (1) is composed of fixed sheet (11) and first sleeve (12); said connector (2) is composed of splice (21), first sleeve (12) and second sleeve (22);
which is characteristic in that:
the upper part of said axle rod (3) insert into second sleeve (22) to fasten, and the lower part of axle rod (3) insert into first sleeve (12) and narrow stick (31), which was shaved into parallel planes; said first sleeve (12) can form a rectangular notch (13) to offer narrow stick (31) of axle rod (3); said rectangular notch (13) is open for upper part and close for end part.

10. A style of safety door hinge design according to claim 1 is characterized in that:
said narrow stick (31) of axle rod (3) and the angle of rectangular notch (13) are in stagger shape in fixed parts (1) and connector (2); after the rotation of connector (2), narrow stick (31) of axle rod (3) can match with rectangular notch (13) in the same angle.

11. A style of safety door hinge design according to claim 1 is characterized in that:
Said rectangular notch (13) has a protecting cover (4) to prevent dust falling from first sleeve (12).

12. A style of safety door hinge design according to claim 11 is characterized in that:
said protecting cover (4) is composed of insertion member (41) of rectangular notch (13) and fixed member (42), which connect with insertion member (41) and cover to outer of first sleeve (12).

13. A style of safety door hinge design according to claim 1 is characterized in that:
Said first sleeve (12) and the outer part of second sleeve (22) have a dustproof cover (5) to prevent from dust.

14. A style of safety door hinge design according to claim 1 is characterized in that:
Said fixed sheet (11) of fixed parts (1) is fasten to the inside part of door frame (6), and splice (21) of connector (2) attach to the side part of door body (7).

15. A style of safety door hinge design according to claim 1 is characterized in that:
Said fixed sheet (11) of fixed parts (1) is fasten to the side part of door body (7), and splice (21) of connector (2) is fasten to the inside part of door frame (6).
